(19) United States
(12) Patent Application Publication
(10) Pub. No.: US 2014/0289050 A1
(43) Pub. Date: Sep. 25, 2014

(54) OUTPUT OF ADVERTISEMENT UTILIZING EXCHANGE OF ITEM DATA

(71) Applicant: YAHOO JAPAN CORPORATION, Tokyo (JP)

(72) Inventor: Yohei NUMATA, Tokyo (JP)

(73) Assignee: YAHOO JAPAN CORPORATION, Tokyo (JP)

(21) Appl. No.: 14/197,861

(22) Filed: Mar. 5, 2014

(30) Foreign Application Priority Data
Mar. 22, 2013 (JP) 2013-060394

(51) Int. Cl. G06Q 30/02

(52) U.S. Cl. CPC G06Q 30/0267
USPC 705/14.64

(57) ABSTRACT

A terminal device includes an owner attribute information holding unit, a program execution unit, an item data holding unit, an output unit, an item data reception unit, a partner attribute information holding unit, an advertisement output unit, and network communication unit. The owner attribute information holding unit holds one or more pieces of owner attribute information. The program execution unit executes a program. The item data holding unit holds item data. The output unit outputs the held item data with the held owner attribute information through short-range wireless communication. The item data reception unit receives the item data with partner attribute information. The partner attribute information holding unit holds the received partner attribute information. The advertisement output unit outputs an advertisement on a basis of the held partner attribute information.

### CROSS-REFERENCE TO RELATED APPLICATIONS

The present application claims priority to and incorporates by reference the entire contents of Japanese Patent Application No. 2013-060394 filed in Japan on Mar. 22, 2013.

### BACKGROUND OF THE INVENTION

1. Field of the Invention

The present invention generally relates to an output of advertisement utilizing exchange of item data.

2. Description of the Related Art

There have been methods and devices for distributing advertisements to terminal devices of users from server devices on a network. Specifically, Japanese Patent Application Laid-open No. 2001-175753 has suggested executing a process in which a user registers pieces of information including an attribute of the user from a terminal device to a center device, the center device extracts an advertisement according to the attribute of the user, and the link information guiding the user to the advertisement is transmitted to the terminal device. The advertisement viewed by the user based on the link information is highly likely to attract the attention of the user, whereby the advertisement effect per unit extraction is high.

In Japanese Patent Application Laid-open No. 2001-175753, however, the volume of the information containing the attribute of the user registered from the terminal device to the center device by the user is not sufficient in many cases. In those cases, the appropriate advertisement distribution is not realized and there is limitation on the advertisement effect. Another problem is that many users tend to access only the advertisement in which they are interested.

### SUMMARY OF THE INVENTION

It is an object of the present invention to at least partially solve the problems in the conventional technology.

According to one aspect of an embodiment, a terminal device includes: an owner attribute information holding unit that holds one or more pieces of owner attribute information; a program execution unit that executes a program; an item data holding unit that holds item data as data of an item that can be used on the program to be executed; an output unit that outputs the held item data with the held owner attribute information through short-range wireless communication including peer-to-peer wireless communication; an item data reception unit that receives the item data with partner attribute information through short-range wireless communication including peer-to-peer wireless communication; a partner attribute information holding unit that holds the partner attribute information received in the item data reception unit; an advertisement output unit that outputs an advertisement on a basis of the held partner attribute information; and a network communication unit.

According to another aspect of an embodiment, an advertisement server device includes: a partner attribute information acquisition unit that acquires the partner attribute information from the terminal device as described above; an advertisement data acquisition unit that acquires data for an advertisement in accordance with the acquired partner attribute information; and an advertisement transmission unit that transmits the acquired advertisement data to the terminal device from which the partner attribute information is acquired.

According to still another aspect of an embodiment, a computer-readable storage medium has stored therein a terminal device driving program for driving a terminal device. The terminal device having an owner attribute information holding unit that holds one or more pieces of owner attribute information. The terminal device driving program causes the terminal device to execute a process including: executing a program; holding item data as data of an item that can be used on the program to be executed; and outputting the held item data with the held owner attribute information through short-range wireless communication including peer-to-peer wireless communication.

According to still another aspect of an embodiment, a program server device includes: a terminal device driving program holding unit that holds the terminal device driving program as described above; a download request reception unit that receives a terminal device driving program download request from a terminal device; and a download unit that downloads the terminal device driving program in response to the terminal device driving program download request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for describing an outline of a first embodiment;

FIG. 2 is a diagram illustrating function blocks of a terminal device of the first embodiment;

FIG. 3 is a diagram illustrating function blocks of an advertisement server device of the first embodiment;

FIG. 4 is a diagram illustrating a hardware structure of the first embodiment;

FIG. 5 is a diagram illustrating a flow of the process in the first embodiment;

FIG. 6 is a schematic diagram for describing an outline of a second embodiment;

FIG. 7 is a diagram illustrating function blocks of the second embodiment;

FIG. 8 is a diagram illustrating a flow of a process in the second embodiment;

FIG. 9 is a schematic diagram for describing an outline of a third embodiment;

FIG. 10 is a diagram illustrating function blocks of the third embodiment;

FIG. 11 is a diagram illustrating a flow of a process in the third embodiment;

FIG. 12 is a schematic diagram for describing an outline of a fourth embodiment;

FIG. 13 is a diagram illustrating function blocks of the fourth embodiment;

FIG. 14 is a diagram illustrating a flow of a process in the fourth embodiment;

FIG. 15 is a schematic diagram for describing an outline of a fifth embodiment;

FIG. 16 is a diagram illustrating function blocks of the fifth embodiment;

FIG. 17 is a diagram illustrating a flow of a process in the fifth embodiment;

FIG. 18 is a diagram illustrating function blocks of a program server device of a sixth embodiment;

FIG. 19 is a first diagram illustrating a flow of a terminal device driving program of the sixth embodiment; and

FIG. 20 is a second diagram illustrating a flow of a terminal device driving program of the sixth embodiment.

### DETAILED DESCRIPTION OF THE PREFERRED EMBODIMENTS

Preferred embodiments for carrying out the present invention are hereinafter described. Note that the present invention is not limited to these embodiments and various modes are applicable without departing from the content of the present invention.

As for the description of the terminal device of the embodiments made below, the outline of the entire process is described first using the schematic diagrams and the like, and then the detailed process content of the components is described based on the function block diagrams. Next, the specific operation content of the hardware resources when the present terminal device is realized by a computer is described based on the hardware structure diagram, and finally the procedure of the process of the present terminal device driving program and the process steps defined in the program for controlling the present terminal device are described.

### First Embodiment

First Embodiment: Outline

A terminal device according to a first embodiment transmits and receives, together with item data as data of an item that can be used on a program to be executed, attribute information of an owner himself or his partner through short-range wireless communication including peer-to-peer wireless communication, and outputs an advertisement based on the received partner attribute information.

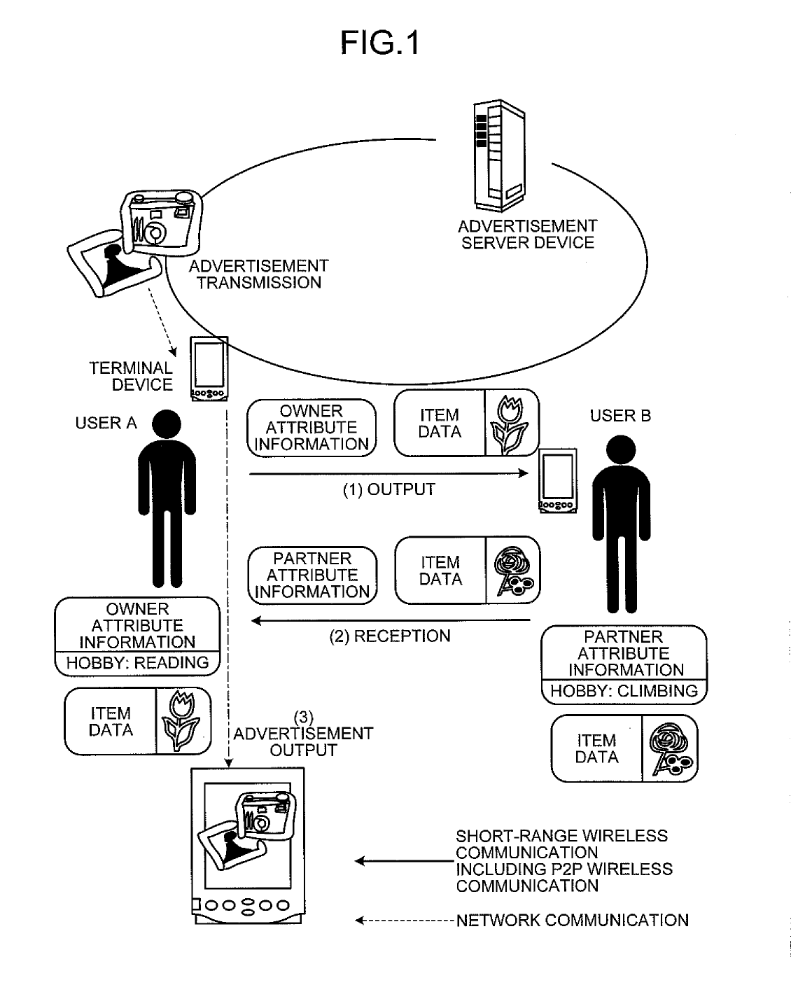

FIG. 1 illustrates an example of the terminal device, etc. according to the first embodiment. FIG. 1 is related to the terminal device that can transmit and receive data to and from another terminal device through the short-range wireless communication including the peer-to-peer wireless communication, and that can receive advertisement distributed from an advertisement server device through the network communication. The terminal device holds the attribute information of the owner and the item data that can be used while the program is executed, and can exchange the attribute information and the item data with a user of another terminal device through the short-range wireless communication. The terminal device can receive the advertisement distributed from the advertisement server device and execute the process for outputting the advertisement.

First, a user A outputs the owner attribute information and the item data held in the own terminal device to a terminal device of a user B through the short-range wireless communication (1). Here, as an example, the owner attribute information of the user A is “hobby: reading” and the item data are represented by a picture of a tulip. The item data refer to the data for structuring the item that can be used on the program that is executed, and if the program is a game, the item data correspond to a character or a tool that a player can get in the game (the details are described later).

Meanwhile, upon the reception of the owner attribute information and the item data from the user A, the user B outputs the owner attribute information of the user B and the item data of the user B. Here, as an example, the owner attribute information of the user B is “hobby: climbing”, and the item data are represented by a picture of a rose. Next, the terminal device of the user A receives the partner attribute information and the item data output from the terminal device of the user B (2). Thus, the exchange of the item data between the users A and B is completed. Note that the item data received from another user may be able to be executed in the program of the terminal device of the user.

Next, the terminal device of the user A holds the received partner attribute information and item data, and outputs an advertisement on the basis of the partner attribute information (3). As for the advertisement based on the partner attribute information, for example, the image is shown in which the advertisement data of a camera targeted to those who have the same hobby and taste as the user B are reproduced and output to the terminal device of the user A. Since this advertisement comes by way of a friend, the user B, the user A is highly likely to view this advertisement positively in relation to the interest in and closeness to the user B. Even when the advertisement is not necessarily interesting because the advertisement is transmitted to many and unspecified people, it is expected that the user A is motivated to access the advertisement depending on the relation with the user B.

First Embodiment: Functional Structure of Terminal Device

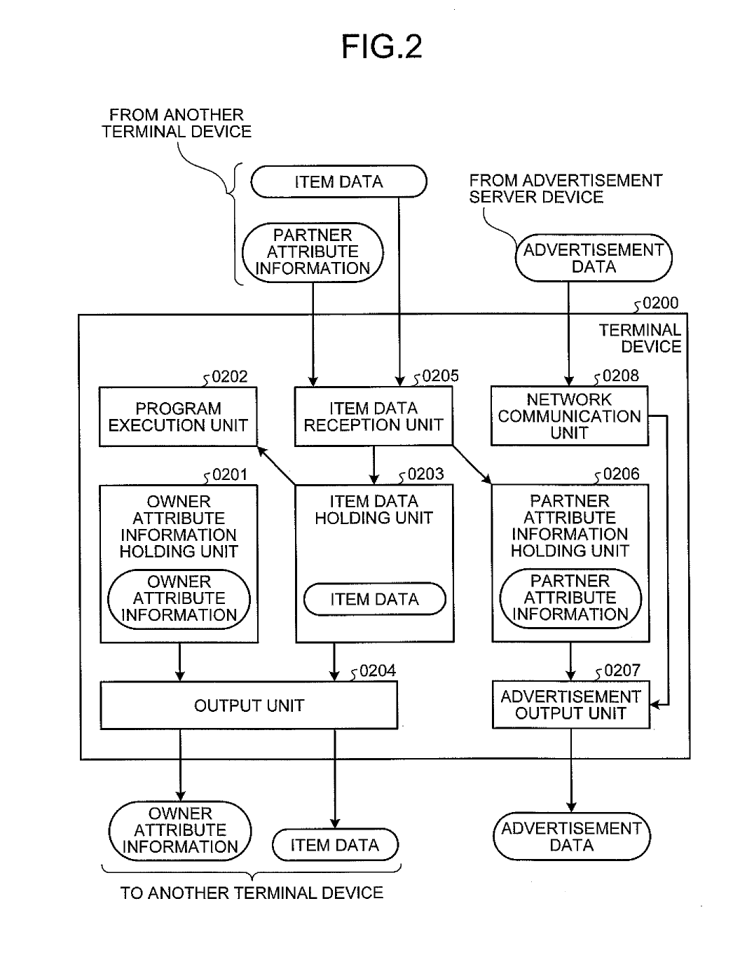

FIG. 2 illustrates an example of the function blocks of the terminal device according to the first embodiment. Each function block to be described later can be achieved when the hardware resources of a computer works with software whose operation is achieved by being developed on a memory to control the hardware. Specifically, the hardware resources of the computer include a CPU (Central Processing Unit), a main memory, a bus, a secondary storage device (such as a hard disk, a nonvolatile memory, a storage medium such as a CD (Compact Disc) or a DVD (Digital Versatile Disc), and a drive for reading out data from those media), an input device used for information input, a printer, a display device, a hardware component of another peripheral device, a communication interface, a driver program for controlling those hardware components, another application program, a user interface application, etc.

Moreover, a calculation process of the CPU is performed according to a program read out from the secondary storage device and developed on the main memory, and the data held in the memory or the hard disk are processed or accumulated or the instruction for controlling the hardware or the software is generated according to the input from the input device or another interface. The function blocks of the present system may be achieved by dedicated hardware. The program for operating the versatile computer or the dedicated hardware may be realized as a moduled program or as one program obtained by combining two or more programs.

Moreover, the first embodiment can achieve not just a device but also a program for driving the terminal device. Additionally, a part of this system can be structured as software. A software product used for executing a software in the computer, and a recording medium in which the product is fixed are also included in the technical scope thereof (this similarly applies throughout the specification).

FIG. 2 illustrates an example of the function blocks of the terminal device according to the first embodiment. A terminal device 0200 of the first embodiment illustrated in FIG. 2 includes an owner attribute information holding unit 0201, a program execution unit 0202, an item data holding unit 0203, an output unit 0204, an item data reception unit 0205, a partner attribute information holding unit 0206, an advertisement output unit 0207, and a network communication unit 0208.

The terminal device 0200 is a device capable of transmitting and receiving data to and from another terminal device through the short-range wireless communication and capable of network communication with a server device, etc. As the short-range wireless communication, NFC (Near Field Communication) is employed and the peer-to-peer wireless communication (P to P: communication method for data exchange between terminals equal on the network that are directly connected to each other) is also included. Other examples of the short-range wireless communication include Bluetooth, infrared data communication, and RFID. The short-range wireless communication enables, not via the server device or the like, the exchange of various data such as the attribute information and the item data just by having the terminal devices approach each other and holding the terminal device on the other. Through the network communication, a terminal device driving program is downloaded from a program server device or advertisement data are received from the advertisement server device.

The owner attribute information holding unit 0201 holds one or more pieces of owner attribute information. The owner attribute information refers to the information related to the attribute of the owner himself, and specifically includes age, sex, occupation, marital status, residence, place of birth, hobby, tastes, or personality, the types of game programs owned, the browsing history of the Internet and advertisements, and the like. The owner attribute information is often generated by the input from the owner himself, and addition, change, or deletion may be performed as necessary. The personality of the user (venturous or conservative, for example) may be generally known from the history of operating the terminal device, such as how the user has played the game. When the owner attribute information has been received by the other terminal device, the owner attribute information is held in the other terminal device as the partner attribute information.

The program execution unit 0202 performs the process for executing the program. In the program, the procedures of the process are described therein so that the terminal device can execute the program, and the program widely covers various application software. Examples of the program include email software, a Web browser, a game program, map software, image/music reproducing software, and an SNS program.

The item data holding unit 0203 holds the item data. The item data refer to the data of the item that can be used on the program to be executed. Specific examples of the item include email, an image, music, voices, an icon, a profile (email address, phone number of owner, etc.), and if the program is a game, a character of the game and a tool that a player can get in the game.

The output unit 0204 outputs the held item data with the held owner attribute information through the short-range wireless communication including the peer-to-peer wireless communication. Specifically, the output through the short-range wireless communication is executed when the own terminal device is held over the partner terminal device. Each of the item data and the owner attribute information may be composed of one or more pieces of data as described above; however, the output data may be either the entire pieces or just some pieces, and which piece of data is output may be selected by the user. The output of the item data together with the owner attribute information may refer to either the output thereof in the state that both the data and the information are mixed or the output thereof in the state that the data and the information are sectioned in separate signal rows. In the latter case, the item data may be output first or the owner attribute information may be output first.

The item data reception unit 0205 receives the item data together with the partner attribute information through the short-range wireless communication including the peer-to-peer wireless communication. The item data reception unit receives the item data output from the other terminal device and the owner attribute information of the partner (partner attribute information). The reception process is also achieved when the own terminal device and the partner terminal device are brought closer to each other and the terminal device is held over the other.

The partner attribute information holding unit 0206 holds the partner attribute information received by the item data reception unit 0205.

The advertisement output unit 0207 performs the process for outputting the advertisement on the basis of the held partner attribute information. The advertisement based on the partner attribute information may refer to the advertisement data transmitted by having the advertisement server device acquire the partner attribute information. The advertisement server device performs the process of extracting the advertisement data in accordance with the partner attribute information and this is described later. In some cases, the advertisement data are not subjected to the process of extracting the advertisement data according to the partner attribute information and are transmitted in a state that the data are bundled without being selected; in these cases, the advertisement data may be extracted based on the partner attribute information in the terminal device.

The process for outputting the advertisement includes the process for displaying and reproducing the advertisement data in the terminal device and causing the terminal device to display the link of the advertisement data and let the user to view the advertisement in the terminal device. The advertisement can be output by the reception of the data for allowing the output of the advertisement from the advertisement server device or the like; alternatively, the advertisement may be streamed from the advertisement server device or the advertisement data transmitted in advance may be held or accumulated by the terminal device, for example. The process for outputting the advertisement may correspond to the process for outputting the advertisement itself or the link information to enable the user to view the advertisement from the terminal device to another terminal device.

When the bundle of the advertisement data is transmitted from the advertisement server device, the process of extracting the advertisement data may be carried out in the terminal device. Specifically, the process of extracting the advertisement data based on the partner attribute information is carried out by comparing the partner attribute information and the attribute information associated with the advertisement data. In other words, in the case where there is no difference between the partner attribute information and the attribute information associated with the advertisement data in advance or where the difference is within a predetermined range, the process of extracting the targeted advertisement data is carried out. For example, if the partner attribute information represents that the hobby of the partner is climbing and the attribute information for having those who like traveling as the target of the advertisement is associated with the advertisement data in advance, the difference between both the attribute information is determined as being within the predetermined range; therefore, the data are acquired as the advertisement data according to the partner attribute information.

The network communication unit 0208 communicates with another server device, etc. The other server device corresponds to, for example, the advertisement server device. The advertisement server device transmits the advertisement data and the terminal device receives the advertisement data. The item data held in the terminal device may be received from the server device or the like via the network communication.

Note that some advertisements may be transmitted without being subjected to the process of extraction based on the partner attribute information from a general advertisement server device. Even in those cases, the network communication unit can receive such advertisements and advertisement output unit 0207 of the terminal device can perform the process of extraction based on the partner attribute information.

First Embodiment: Functional Structure of Advertisement Server Device

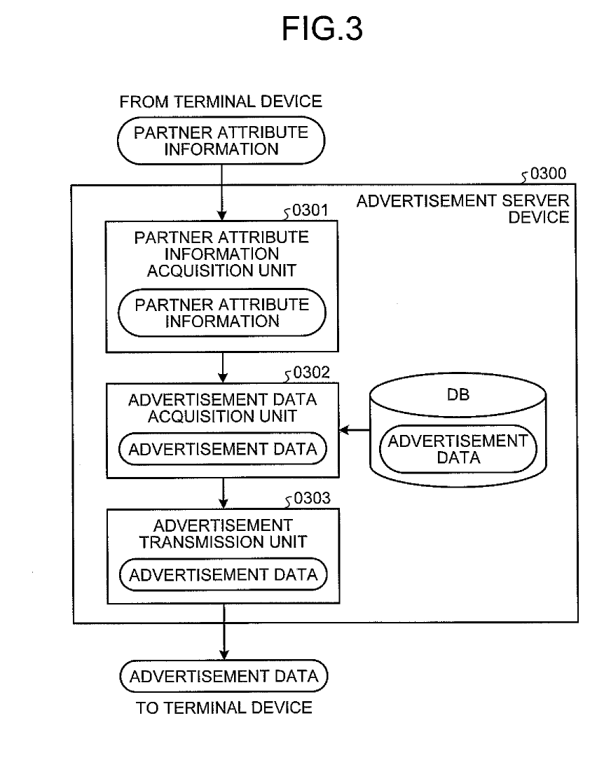

FIG. 3 illustrates an example of the function blocks of the advertisement server device according to the first embodiment. An advertisement server device 0300 of the first embodiment illustrated in FIG. 3 includes a partner attribute information acquisition unit 0301, an advertisement data acquisition unit 0302, and an advertisement transmission unit 0303.

The advertisement server device 0300 is a server device that accumulates the advertisement data supplied from an advertiser and transmits the advertisement data to the terminal device.

The partner attribute information acquisition unit 0301 acquires the partner attribute information from the terminal device. For example, the partner attribute information acquisition unit acquires the partner attribute information transmitted from the terminal device along with the execution of the process for outputting the advertisement. Alternatively, the partner attribute information acquisition unit acquires the partner attribute information to be returned by requesting the terminal device having accessed the advertisement server device for acquisition.

The advertisement data acquisition unit 0302 acquires the data for the advertisement according to the acquired partner attribute information. The data for the advertisement include, in addition to the data constituting the advertisement, the address of the homepage that enables the user to view the advertisement, etc. The advertisement data according to the partner attribute information refer to the advertisement data as the target when the difference obtained as a result of comparing the partner attribute information and the attribute information associated with the advertisement data in advance is not found or the difference is within the predetermined range. The data for the advertisement are accumulated in a database or the like and are retrieved as appropriate from the database, so that the appropriate data are obtained.

The advertisement transmission unit 0303 transmits the acquired advertisement data to the terminal device that has acquired the partner attribute information. The advertisement data are transmitted mainly via the network communication.

First Embodiment: Hardware Structure

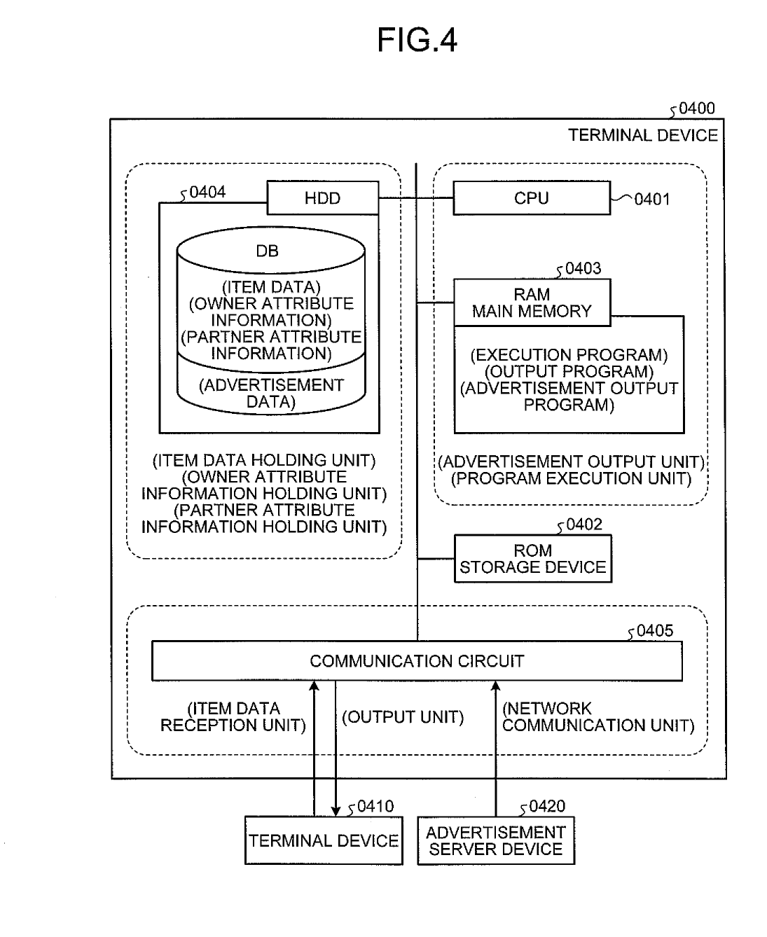

FIG. 4 is a schematic diagram illustrating an example of a hardware structure of a terminal device according to the first embodiment. With reference to FIG. 4, description is made of the operation of the hardware structure in the execution of the process of each component in this system.

A terminal device 0400 of the first embodiment illustrated in FIG. 4 includes a CPU 0401, a ROM (Read Only Memory)/storage device 0402, a RAM (Random Access Memory)/main memory 0403, an HDD (Hard Disk Drive) 0404, and a communication circuit 0405. The ROM 0402 stores various programs that are executed in the CPU 0401. The RAM 0403 provides a work region where the program is read and developed for executing the program stored in the ROM, and a data region where the data are stored temporarily.

Upon the acquisition of data to be the trigger via the communication circuit 0405, the program or the data are read out in the RAM. Along with the execution of the process in the program execution unit, the CPU specifies the memory address of the ROM or the RAM and accesses the memory with reference to the readout program, whereby the data are mutually exchanged and various calculation processes are conducted in regard to the data according to the procedure shown in the program. This achieves the functions of the units or the function related to the calculation process of another component. The data obtained by the calculation process or the like are exchanged mutually through the communication path such as a system bus.

The HDD 0404 holds the item data, the owner attribute information, the partner attribute information, and the like by the execution of the process in the item data holding unit, the owner attribute information holding unit, and the partner attribute information holding unit. The terminal device 0400 communicates with another terminal device 0410 using NFC as a communication circuit for achieving the process in the item data reception unit and the output unit. Similarly, the terminal device communicates with the advertisement server device 0420 using LAN as a communication circuit for achieving the process in the network reception unit. The aforementioned function is the function of the hardware structure (similarly applies throughout this specification).

Here, the procedure of the process in the present terminal device is described in order. First, upon the start-up of the terminal device, the execution program that is stored in the ROM for achieving the process of the program execution unit is set in the work region of the RAM. If the user then operates to execute the program by using an input device, for example, the CPU executes the execution program set in the work region of the RAM. For example, the execution program is used to search for the item data held in the HDD to obtain the item data, and display the item data.

If the user operates to output the item data and the owner attribute information, this operation triggers the execution of the output program by the CPU for achieving the process in the output unit which has been set in the work region of the RAM. After having searched for the item data and the owner attribute information held in the HDD and obtained the data and the information, the output program outputs the data and the information to another terminal device through the short-range wireless communication using the NFC as the communication circuit.

Meanwhile, the other terminal device may similarly output to the terminal device of the owner, the item data and the partner attribute information as the attribute information of the partner through the short-range wireless communication using the NFC as the communication circuit. On this occasion, the terminal device of the owner receives the data and the information through the communication circuit, and stores the data and the information in the data region of the RAM or the like. Then, the terminal device of the owner registers the data and the information in a DB of the HDD, thereby achieving the process in the item data reception unit.

When the user operates to output the advertisement, this operation triggers the execution of the advertisement output program by the CPU for achieving the process in the advertisement output unit which has been set in the work region of the RAM. The advertisement output program may be configured to output the partner attribute information held in the HDD to the advertisement server device through the network communication using LAN as the communication circuit, so that the advertisement server device acquires the partner attribute information. The advertisement server device performs the process for extracting the advertisement data in accordance with the partner attribute information, and sends the advertisement data back to the terminal device. The terminal device receives the advertisement data and executes the process of, for example, displaying and reproducing the advertisement data via an output device, which is not shown.

Alternatively, the advertisement output program may be configured to perform the process for executing the process of extracting the advertisement data on the basis of the partner attribute information in the terminal device. The process of extracting the advertisement data can be achieved by comparing the partner attribute information and the attribute information of the advertisement data encoded and associated with the advertisement data in advance. Specifically, a difference between the advertisement data attribute information and the partner attribute information is obtained, and if the difference is not found or is within a predetermined range, the advertisement data are extracted. The extracted advertisement data are the data judged as being appropriate based on the partner attribute information, and the advertisement data are subjected to the process of, for example, display and reproduction via an output device which is not shown.

The advertisement output program may be configured to perform the process of outputting the advertisement from the terminal device to another terminal device, or the process of outputting from the terminal device to another terminal device, the link information that allows the user to view the advertisement.

Although the execution of the advertisement output program is triggered by the operation of the user, the present invention is not limited thereto; for example, the execution may be triggered by the reception of the partner attribute information from the partner terminal device or may be performed for every predetermined period.

First Embodiment: Process Flow

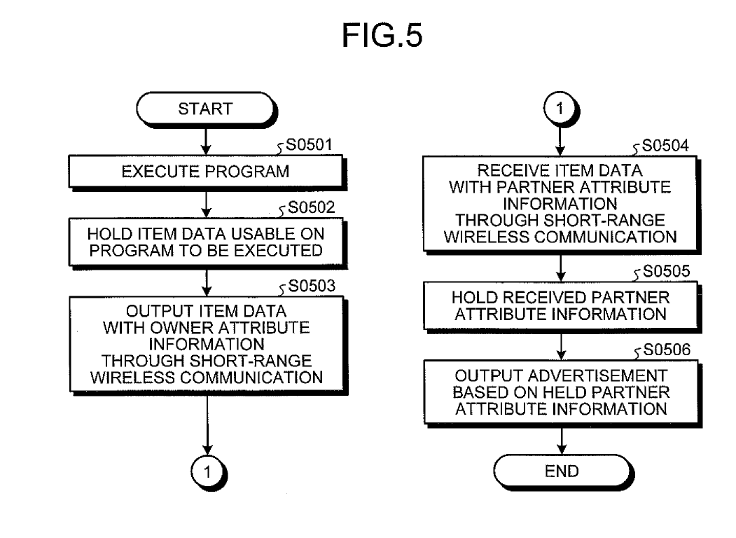

FIG. 5 illustrates an example of the flow of the process in the terminal device according to the first embodiment. The flow of the process described below can be executed in the computer, and this program can be recorded in a computer-readable recording medium (this similarly applies to the other process flows throughout this specification).

First, it is premised that the present terminal device holds one or more pieces of owner attribute information. In the first step, the terminal device executes a program (S0501). Next, the terminal device holds the item data, which are the data of the item that can be used on the program to be executed (S0502). Next, the terminal device outputs the held item data with the held owner attribute information through the short-range wireless communication including the peer-to-peer wireless communication (S0503). Moreover, the terminal device receives the item data with the partner attribute information through the short-range wireless communication including the peer-to-peer wireless communication (S0504). Then, the terminal device holds the received partner attribute information (S0505). Finally, the process for outputting the advertisement based on the held partner attribute information is executed (S0506).

First Embodiment: Effect

The terminal device of the first embodiment has an effect that the advertisement distribution with a higher sales promotion effect can be achieved by using the attribute information received from an actually facing partner through the short-range wireless communication including the peer-to-peer wireless communication and outputting the advertisement based on the partner attribute information. In other words, since the advertisement received by the user is the advertisement that comes from the partner in a close relationship whom the user actually faces and with whom the user performs the short-range wireless communication, the advertisement is highly likely to be viewed positively in relation to the interest in and closeness to the communication partner. Even when the advertisement is not necessarily interesting because the advertisement is transmitted to many and unspecified people, it is expected that the user is motivated to access the advertisement depending on the relation with the communication partner.

### Second Embodiment

Second Embodiment: Outline

A terminal device according to a second embodiment has a feature in that the advertisement output is controlled based on the number of times of receiving the item data for each partner.

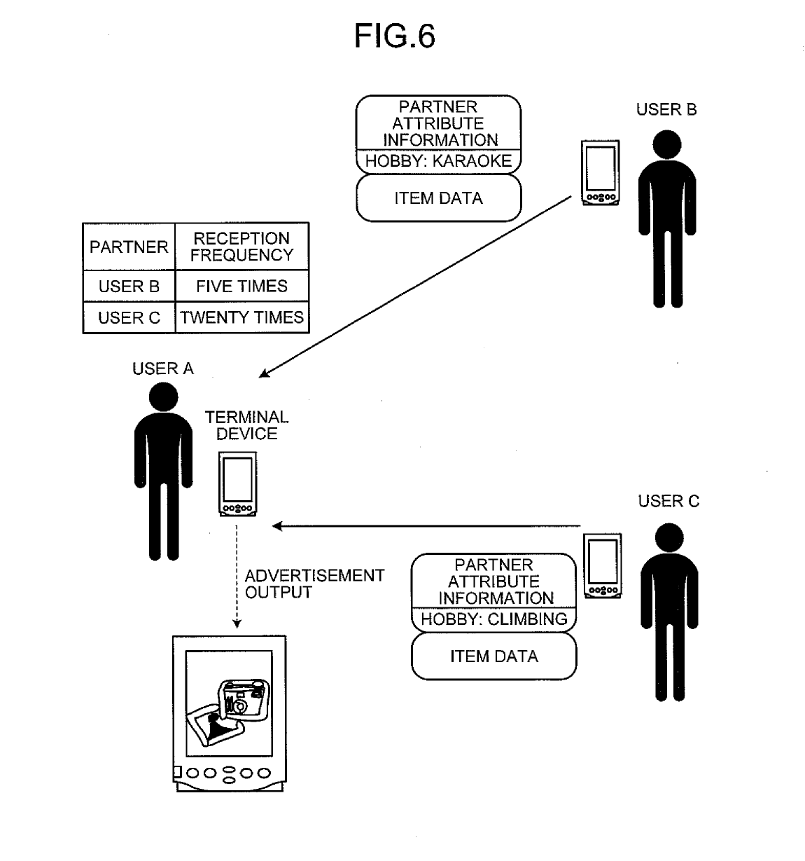

FIG. 6 illustrates an example of the terminal device according to the second embodiment. The portion added to the first embodiment is mainly described. Here, an example is shown in which the user A outputs his own owner attribute information and the item data and receives the partner attribute information and the item data from the user B or C. Here, the user A has received the item data from the user B five times and from the user C twenty times in the past. In the second embodiment, the advertisement output is controlled in accordance with the number of times of receptions for every user. For example, when the advertisement targeted to the people having the hobby and likes is output as the advertisement based on the partner attribute information, the advertisement related to climbing (the advertisement of a camera in FIG. 6) extracted based on the partner attribute information of the user C, from whom the user A receives the item data frequently, is distributed with a larger size than the advertisement related to karaoke extracted based on the partner attribute information of the user B; alternatively, the advertisement extracted based on the partner attribute information of the user C is distributed more frequently than the advertisement for the user B.

Second Embodiment: Functional Structure

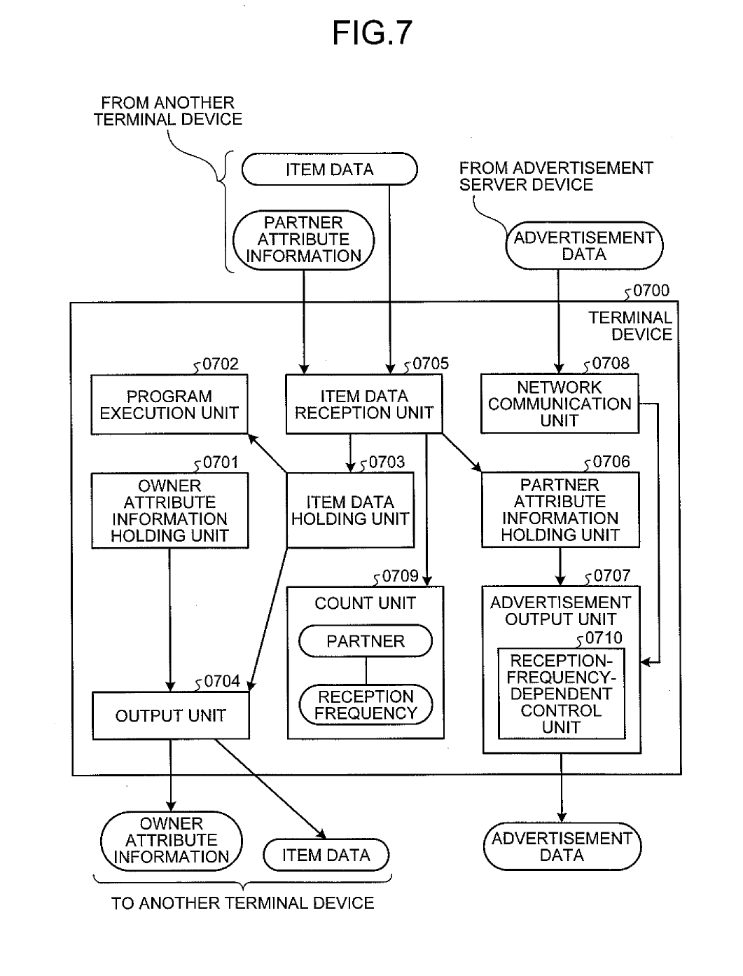

FIG. 7 illustrates an example of the function blocks of a terminal device according to the second embodiment. A terminal device 0700 of the second embodiment illustrated in FIG. 7 includes: an owner attribute information holding unit 0701, a program execution unit 0702, an item data holding unit 0703, an output unit 0704, an item data reception unit 0705, a partner attribute information holding unit 0706, an advertisement output unit 0707, a network communication unit 0708, and a count unit 0709, and the advertisement output unit 0707 includes a reception-frequency-dependent control unit 0710. Note that the terminal device, the owner attribute information holding unit, the program execution unit, the item data holding unit, the output unit, the item data reception unit, the partner attribute information holding unit, the advertisement output unit, and the network communication unit are similar to those of the first embodiment (FIG. 2); therefore, the description is not made of those units.

The count unit 0709 counts the number of times of receiving the item data for every partner. When the item data reception unit 0705 receives the item data and the partner attribute information, the count unit counts the number of times of receiving the item data for every partner. The obtained data on the number of times of reception are held in the form of a table in association with the information for identifying the users.

The reception-frequency-dependent control unit 0710 controls the advertisement output based on the partner attribute information in accordance with the number of times of reception for every partner. The control over the advertisement output refers to the control as to whether a special advertisement is output or not, the frequency of the advertisement output, and the relative volume of the advertisement. The control over the advertisement output is carried out depending on the reception frequency, and may be executed as above if the item data are received for a certain number of times or more, and the frequency of the advertisement output and the volume of the advertisement may be increased as the number of times of reception is increased.

For example, as the user receives the item data more frequently from another user having the attribute information representing that his hobby is climbing, the advertisements related to traveling, mountains, nature, etc. are displayed and reproduced on the own terminal device frequently.

Second Embodiment: Hardware Structure

A hardware structure of the terminal device according to the second embodiment is described with reference to FIG. 4. The portion added to the first embodiment is mainly described. In this embodiment, the ROM 0402 stores the count program in addition to the execution program, etc. and the count program is set to the work region of the RAM 0403 along with the start-up of the terminal device.

First, when another terminal device 0410 outputs the item data and the partner attribute information as the attribute information of the partner to the terminal device 0400, the terminal device 0400 receives the data and the information through the short-range wireless communication via the communication circuit 0405. The received data are stored in the data region or the like in the RAM and then registered in the DB of the HDD 0404. Thus, the process in the item data reception unit is completed. On this occasion, the storage of the item data, etc. in the RAM triggers the execution of the count program set in the work region of the RAM by the CPU 0401, thereby achieving the process in the count unit.

The count program performs the process of holding the information in the RAM or the like in the form of a table in which the information for identifying the users and the number of times of receiving the item data for each partner are associated with each other. After that, the count program performs the process of incrementing the number of times of reception for every partner whenever the user receives the item data.

In the case where the user operates to output the advertisement to the terminal device, this operation triggers the execution of the advertisement output program for achieving the process in the advertisement output unit that has been set to the work region of the RAM by the CPU. The process of the advertisement output program is similar to that of the first embodiment; in the second embodiment, moreover, the advertisement output is controlled based on the number of times of receiving the item data for every partner.

Specifically, the number of times of receiving the item data for every partner held in the form of the table is read out and if the number of times of receiving the item data is greater than or equal to a predetermined number, a particular piece of advertisement data (for example, special advertisement data or advertisement data with a large volume) may be displayed and reproduced on an output device or the like. Moreover, the number of times of outputting the advertisement in a predetermined period may be increased as the number of times of receiving the item data is increased. This can be achieved by increasing the frequency of executing the advertisement output program. The execution of the advertisement output program may be triggered by the operation of the user or the reception of the partner attribute information from the partner terminal device, or be executed for every predetermined period. For increasing the frequency of executing the advertisement output program, the interval of the execution of the advertisement output program may be shortened.

Second Embodiment: Process Flow

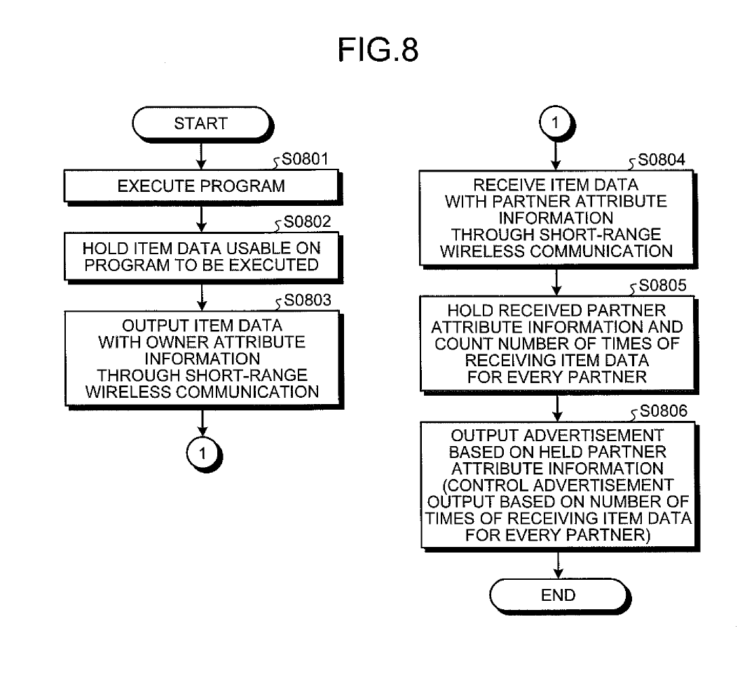

FIG. 8 illustrates an example of the flow of the process in the terminal device of the second embodiment. The portion added to the description in the first embodiment (FIG. 5) is mainly described. First, it is premised that the present terminal device has the owner attribute information holding unit that holds one or more pieces of the owner attribute information.

As the first step, the terminal device executes a program (S0801). Next, the terminal device holds the item data as the data of the item that can be used on the program to be executed (S0802). Subsequently, the terminal device outputs the held item data together with the held owner attribute information through the short-range wireless communication including the peer-to-peer wireless communication (S0803). Meanwhile, the item data with the partner attribute information are received through the short-range wireless communication including the peer-to-peer wireless communication (S0804). Next, the received partner attribute information is held and the number of times of receiving the item data for every partner is counted (S0805). Finally, the process for outputting the advertisement based on the held partner attribute information is performed. On this occasion, the advertisement output is controlled based on the number of times of receiving the item data for every partner (S0806).

Second Embodiment: Effect

The terminal device of the second embodiment has an effect that the advertisement distribution with a higher sales promotion effect can be achieved by controlling the advertisement output in accordance with the number of times of receiving the item data for every partner. The user having received the advertisement is highly likely to view the advertisement that comes from the partner whom the user frequently meets positively in relation to the interest in and closeness to the partner, and additionally, the particular advertisement (for example, the advertisement with the special content or with large volume) or the advertisement frequently distributed is expected to be more effective.

### Third Embodiment

Third Embodiment: Outline

A terminal device of a third embodiment has a feature in that when the item data of a user are output to a partner with whom the user has played a match game through short-range wireless communication, the owner attribute information to be output with the item data is increased.

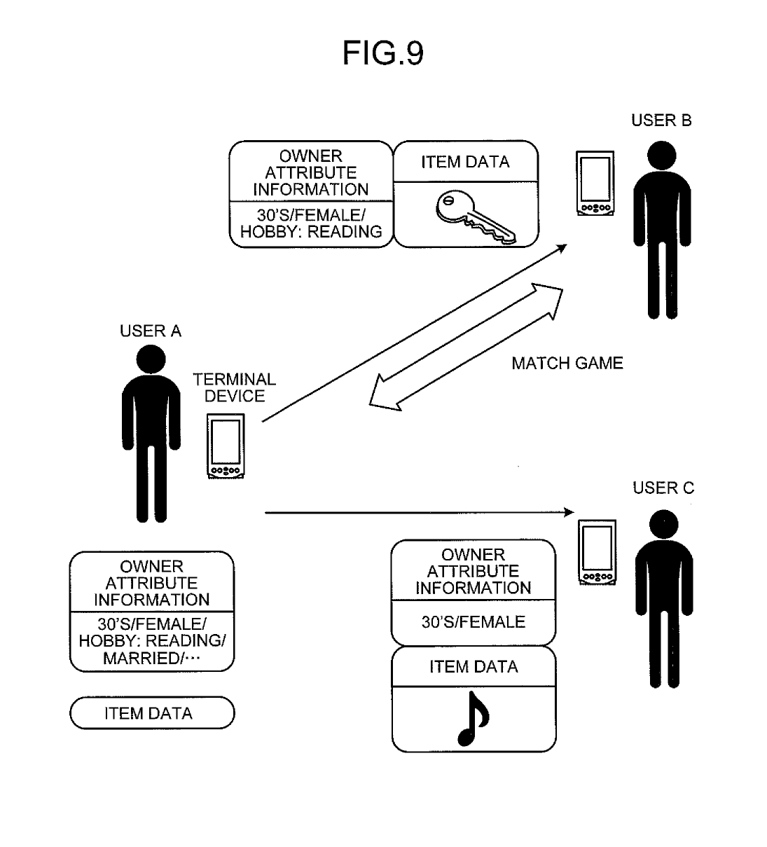

FIG. 9 illustrates an example of the terminal device of the third embodiment. The portion added to the first and second embodiments is mainly described. An example is shown in which the user A and the user B play the match game program and the user A outputs the item data to the user B using the short-range wireless communication. Meanwhile, in this example, the user A and the user C do not play the match game program but play a music reproduction program and output the music data used in the music reproduction program as the item data.

The user A holds a plurality of pieces of data including age, sex, occupation, and marital status as the owner attribute information. The terminal device of the third embodiment has a feature in that the owner attribute information is increased when the item data are output to the partner with whom the owner has played the match game. For example, the user A outputs just two pieces of owner attribute information, “age” and “sex”, to the user C while the user A outputs three pieces of owner attribute information, “age”, “sex”, and “hobby” to the user B. Since the user A shares long time with the user B in the game and they are regarded as being in a close relationship, the user A outputs more attribute information to the user B to let the user B know more about himself.

Third Embodiment: Functional Structure

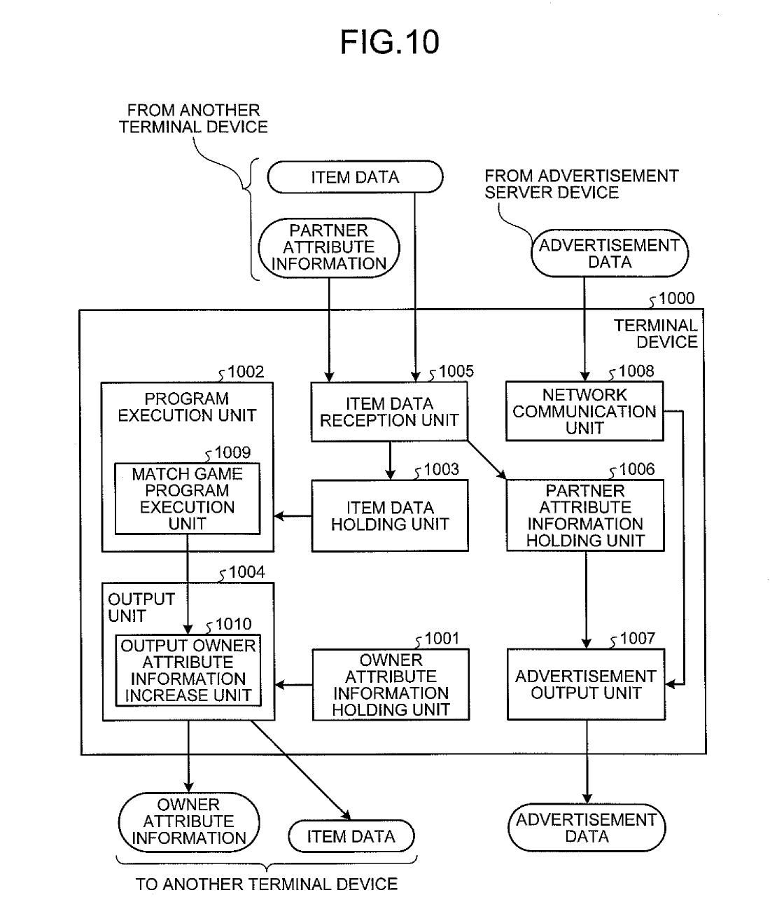

FIG. 10 illustrates an example of the function blocks of the terminal device of the third embodiment. A terminal device 1000 of the third embodiment illustrated in FIG. 10 includes an owner attribute information holding unit 1001, a program execution unit 1002, an item data holding unit 1003, an output unit 1004, an item data reception unit 1005, a partner attribute information holding unit 1006, an advertisement output unit 1007, and a network communication unit 1008. The program execution unit 1002 has a match game program execution unit 1009, and the output unit 1004 has an output owner attribute information increase unit 1010. Note that since the terminal device, the owner attribute information holding unit, the program execution unit, the item data holding unit, the output unit, the item data reception unit, the partner attribute information holding unit, the advertisement output unit, and the network communication unit are similar to those of the first embodiment (FIG. 2), the description of those units is omitted. Although not described, the count unit and the reception-frequency-dependent control unit in the advertisement output unit may be added. In that case, the count unit and the reception-frequency-dependent control unit are similar to those of the second embodiment (FIG. 7); therefore, the description is omitted.

The match game program execution unit 1009 executes the match game program. The match game refers to the games in which players fight or compete with each other, and include Othello, Shogi, a shooting game, a simulation game, a fighting game, and a sport game. The item data that can be used on the match game program to be executed refer to the character of the game, the tool that the player can get in the game, or the attack of the player.

When the item data are output to a partner on the match game through the short-range wireless communication including the peer-to-peer wireless communication, the output owner attribute information increase unit 1010 increases the owner attribute information to be output with the item data. When the program to be executed is the match game, the increase of the information may be notified from the match game program execution unit 1009. In this case, the process of increasing the output owner attribute information is executed.

The owner attribute information refers to the information related to the attribute of the owner, and specific examples thereof include age, sex, occupation, marital status, residence, place of birth, hobby, and likes. The increase in output owner attribute information refers to, for example, the increase in number of items given above or the details of each item (for example, in the item of age, the age is generally expressed in periods of ten years but here is expressed as the exact age).

Third Embodiment: Hardware Structure

The hardware structure of the terminal device of the third embodiment is described with reference to FIG. 4. The portion added to the first and second embodiments is mainly described.

First, when the user operates to execute the match game program by using the input device or the like, the CPU 0401 executes the execution program set to the work region of the RAM 0403. For example, the execution program is used to search for the item data held in the HDD 0404 to obtain the item data, and then display the item data.

When the user operates to output the item data and the owner attribute information along with the execution of the match game program, this operation triggers the execution of the output program set to the work region of the RAM by the CPU for achieving the process in the output unit. Upon the acquisition of the owner attribute information and the item data held in the HDD, the output program outputs the information and the data to another terminal device 0410 through the short-range wireless communication using the NFC as the communication circuit 0405. On this occasion, if the terminal device to which the data are output is judged as the terminal device of the partner with whom the user has played the match game on the basis of the partner attribute information, the process of increasing the owner attribute information is executed. Specifically, when the owner attribute information as the output target is extracted from the held owner attribute information, the number of items is increased or the details of each item are selected and extracted. Moreover, the priority order of the output may be set among the pieces of owner attribute information in the form of priority codes, and the owner attribute information as the output target may be extracted based on the priority code.

Third Embodiment: Process Flow

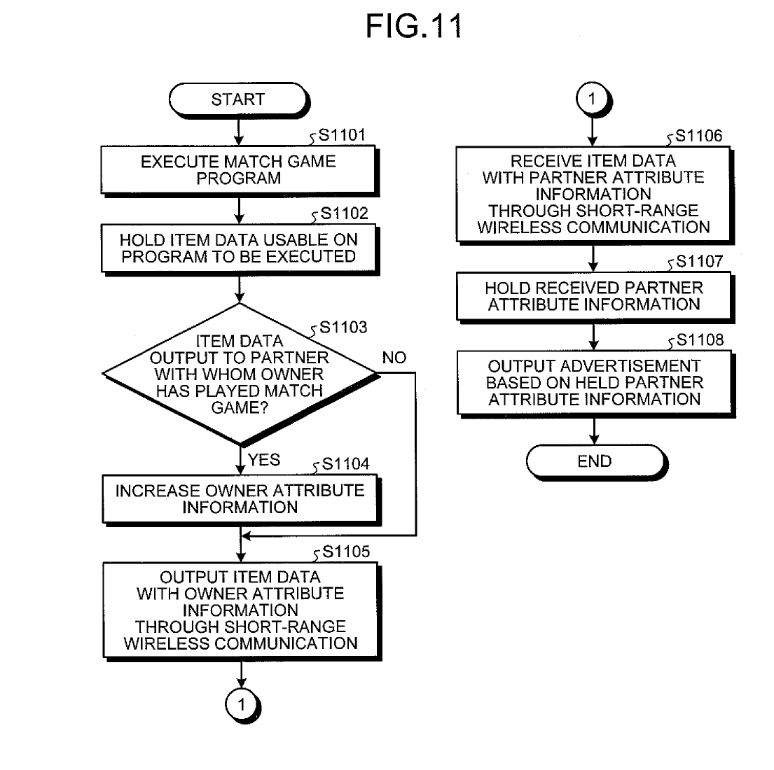

FIG. 11 illustrates an example of the flow of the process in the terminal device of the third embodiment. The portion added to the descriptions in the first embodiment (FIG. 5) and the second embodiment (FIG. 8) is mainly described. First, it is premised that the present terminal device has the owner attribute information holding unit that holds one or more pieces of owner attribute information.

As the first step, the terminal device executes a match game program (S1101). Next, the terminal device holds the item data that can be used on the program to be executed (S1102). Subsequently, the terminal device of the owner judges whether the item data are output to the terminal device of the partner with whom the owner has played the match game through the short-range wireless communication including the peer-to-peer wireless communication (S1103). If the judgment results indicate that the item data are output to the partner with whom the owner has played the match game, the owner attribute information to be output with the item data is increased (S1104) and the information and the item data are output through the short-range wireless communication including the peer-to-peer wireless communication (S1105). If the judgment results indicate that the item data are not output to the partner with whom the owner has played the match game, the normal owner attribute information and the item data are output through the short-range wireless communication including the peer-to-peer wireless communication (S1105).

The subsequent process is performed similarly: the partner attribute information and the item data are received from another terminal device through the short-range wireless communication including the peer-to-peer wireless communication (S1106), the information and the data are held (S1107), and the information and the data are subjected to the process for outputting the advertisement based on the held partner attribute information (S1108).

Third Embodiment: Effect

In the terminal device of the third embodiment, the owner attribute information is increased when the item data are output to the partner with whom the owner has played the match game, whereby more of the owner attribute information is sent to the partner in a close relationship. It is expected that the match game is often played for a relatively long time; in this case, the advertisement utilizing the attribute of the users who share long time can be distributed, which provides the effect of achieving the advertisement distribution with a higher sales promotion effect.

### Fourth Embodiment

Fourth Embodiment: Outline

A terminal device of a fourth embodiment has a feature in that the output of the owner attribute information is controlled based on the number of times of approaching another terminal device.

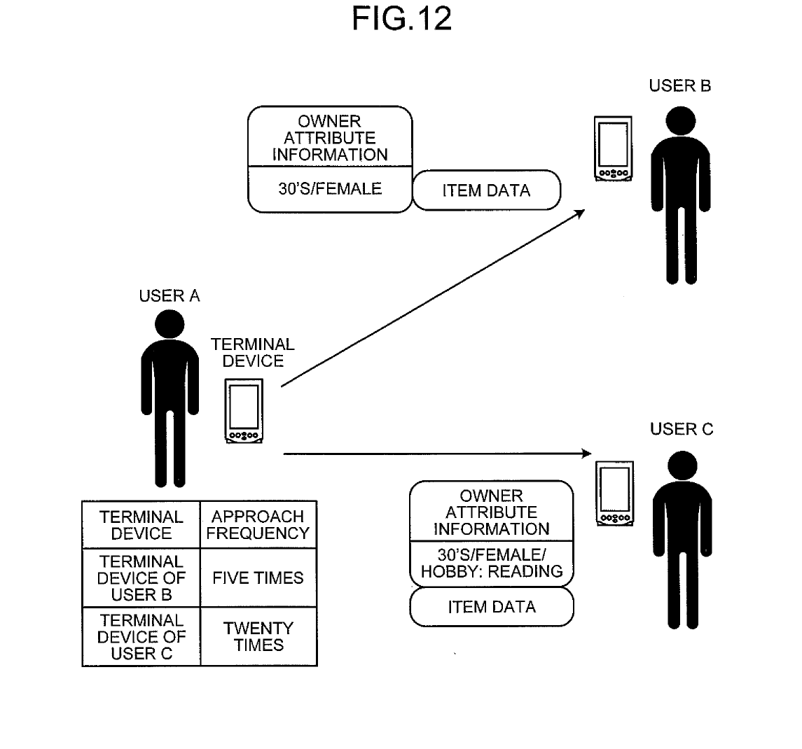

FIG. 12 illustrates an example of the terminal device of the fourth embodiment. The portion added to the first to third embodiments is mainly described. Here, an example is shown in which upon the detection of the approach of the terminal device of the user A within a certain distance range from the terminal device of the user B or the user C, the number of times of approaches is counted. It is assumed that the number of times of approaches to the terminal device of the user B is five times while that to the terminal device of the user C is twenty times. In the fourth embodiment, the output of the owner attribute information is controlled in accordance with the number of times of approaches for every terminal device. For example, the user A outputs just two pieces of owner attribute information, “age” and “sex”, to the user B while the user A outputs three pieces of owner attribute information, “age”, “sex”, and “hobby” to the user C.

Fourth Embodiment: Functional Structure

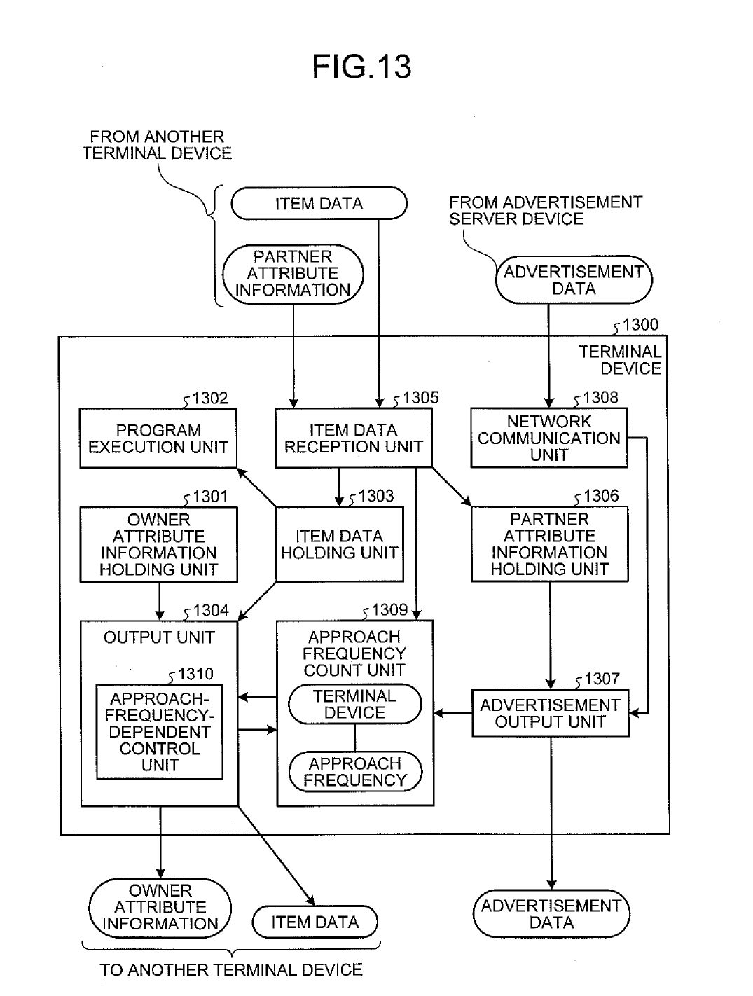

FIG. 13 illustrates an example of the function blocks of the terminal device in the fourth embodiment. A terminal device 1300 of the third embodiment illustrated in FIG. 13 includes an owner attribute information holding unit 1301, a program execution unit 1302, an item data holding unit 1303, an output unit 1304, an item data reception unit 1305, a partner attribute information holding unit 1306, an advertisement output unit 1307, a network communication unit 1308, and an approach frequency count unit 1309. The output unit 1304 includes an approach-frequency-dependent control unit 1310. Since the terminal device, the owner attribute information holding unit, the program execution unit, the item data holding unit, the output unit, the item data reception unit, the partner attribute information holding unit, the advertisement output unit, and the network communication unit are similar to those of the first embodiment (FIG. 2), the description is omitted. Although not illustrated, the count unit and the reception-frequency-dependent control unit in the advertisement output unit may be provided. In this case, the count unit and the reception-frequency-dependent control unit are similar to those of the second embodiment (FIG. 7); thus, the description is omitted. Further, although not illustrated, the program execution unit may have the match game program execution unit and the output unit may have the output owner attribute information increase unit. In this case, since the match game program execution unit and the output owner attribute information increase unit are similar to those of the third embodiment (FIG. 10), the description is omitted.

The approach frequency count unit 1309 counts the number of times of approaches to another terminal device for every terminal device. The number of times of approaches for every terminal device may refer to the number of times of transmissions and receptions of the item data and the attribute information, and moreover the number of times of approaches between the terminal devices within a predetermined distance range. Specifically, the item data reception unit 1305 receives the item data and the partner attribute information and the output unit 1304 outputs the owner attribute information and the item data; on this occasion, the number of times of approaches is counted for every terminal device. Even though the data are not transmitted or received, once the terminal device approaches within the predetermined distance range from another terminal device and this approach is detected with a sensor or the like, the approach may be counted. The obtained data on the number of times of approaches are held once in the form of a table in association with the terminal device (identification information of the terminal device).

The approach-frequency-dependent control unit 1310 controls the output of the owner attribute information in accordance with the number of times of approaches counted for every terminal device. The output control based on the number of times of approaches may refer to the control of the output that is made stepwise as the number of times increases or the output that is made based on a predetermined number of times as the threshold. The output control of the owner attribute information includes the case in which the owner attribute information is not output.

The owner attribute information refers to the information related to the attribute of the owner, and specific examples thereof include age, sex, occupation, marital status, residence, place of birth, hobby, and likes. The output control of the owner attribute information includes the output of more or fewer items among the items in the above specific example, the output of just the summary of each item, or the output of the details of the item (for example, in the item of age, the age is expressed in periods of ten years or expressed as the exact age).

Fourth Embodiment: Hardware Structure

The hardware structure of the terminal device of the fourth embodiment is described with reference to FIG. 4. The portion added to the first to third embodiments is mainly described. In the fourth embodiment, the ROM 0402 stores an approach frequency count program in addition to the execution program and the like, and the approach frequency count program is set to the work region of the RAM 0403 along with the start-up of the present terminal device 0400.

First, the terminal device outputs the owner attribute information and the item data to another terminal device 0410 through the short-range wireless communication via the communication circuit 0405 according to the operation of the user. Further, the terminal device receives the partner attribute information and the item data output from the other terminal device. The execution of these operations triggers the execution of the approach frequency count program set to the work region of the RAM by the CPU 0401 for achieving the process in the approach count unit. In addition, upon the detection of the approach of the other terminal device within the predetermined distance range with a sensor, which is not shown, the approach count program may be executed.

The approach count program performs the process of forming the table by associating the identification information of the other terminal device and the number of times of approaches for every terminal device and holding the table in the RAM or the like. After that, the approach count program performs the process of incrementing the number of times of approaches for every terminal device whenever the terminal device approaches another device.

In the case where the user operates to output the item data and the owner attribute information, this operation triggers the execution of the output program set to the work region of the RAM by the CPU for achieving the process in the output unit. Upon the acquisition of the owner attribute information and the item data held in the HDD 0404, the output program outputs the data and the information to another terminal device through the short-range wireless communication using the NFC as the communication circuit. On this occasion, the process of controlling the output of the owner attribute information in accordance with the number of times of approaches counted for every terminal device is performed. Specifically, when the piece of the owner attribute information as the output target is extracted out of the held owner attribute information, the number of times of approaches for every terminal device held in the form of the table is read out; if the number of times of approaches is more than or equal to a predetermined number, the number of items to be output among the owner attribute information is increased or the detailed description of each item is selected and extracted. Moreover, the priority order of the output may be set among the pieces of owner attribute information in the form of priority codes, and the owner attribute information as the output target may be extracted based on the priority code.

Fourth Embodiment: Process Flow

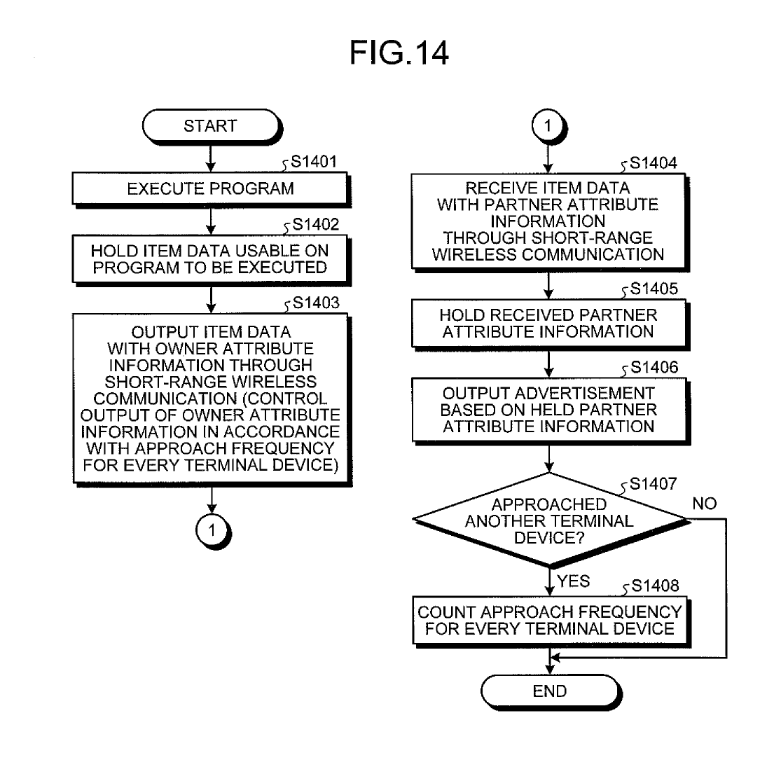

FIG. 14 illustrates an example of the flow of the process in a terminal device of the fourth embodiment. The portion added to the descriptions in the first embodiment (FIG. 5), the second embodiment (FIG. 8), and the third embodiment (FIG. 11) is mainly described. First, it is premised that the present terminal device has the owner attribute information holding unit that holds one or more pieces of owner attribute information.

As the first step, the terminal device executes a program (S1401). Next, the terminal device holds the item data as the data of the item that can be used on the program to be executed (S1402). Subsequently, the terminal device outputs the held item data with the held owner attribute information through the short-range wireless communication including the peer-to-peer wireless communication (S1403). On this occasion, the output of the owner attribute information is controlled based on the number of times of approaches for every terminal device (when the terminal device approaches another terminal device for outputting the item data and the owner attribute information, the number of times of approaches for every terminal device is incremented).

On the other hand, the item data with the partner attribute information are received through the short-range wireless communication including peer-to-peer wireless communication (S1404) (in this case, similarly, when the terminal device approaches another terminal device for receiving the item data and the partner attribute information, the number of times of approaches for every terminal device is incremented). Next, the received partner attribute information is held (S1405). Subsequently, the process for outputting the advertisement based on the held partner attribute information is performed (S1406). Moreover, whether the terminal device has approached another terminal device is judged with a sensor or the like (S1407) and if the judgment results indicate that the device has approached the device, the number of times of approaches is counted for every terminal device (S1408) and then the process ends.

Fourth Embodiment: Effect

The terminal device of the fourth embodiment can distribute the advertisements more widely by controlling the output of the owner attribute information in accordance with the number of times of approaching the other terminal device to collect the owner attribute information in many places.

### Fifth Embodiment

Fifth Embodiment: Outline

A terminal device of a fifth embodiment has a feature in that the output of the owner attribute information is controlled in accordance with the friendship information held by the execution of an SNS program.

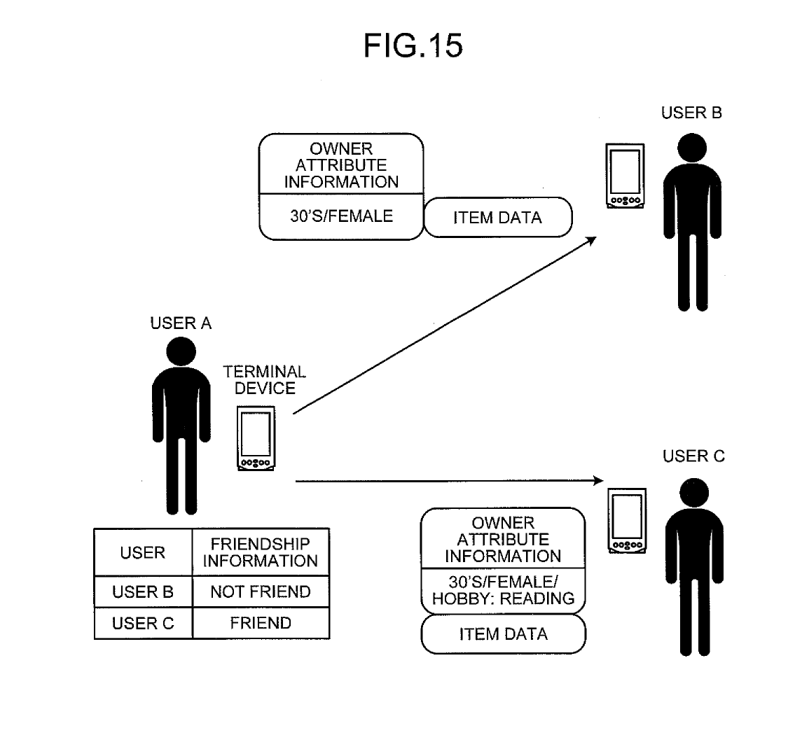

FIG. 15 illustrates an example of the terminal device of the fifth embodiment. The portion added to the first to fourth embodiments is mainly described. Here, it is premised that the user A and the user C are friends, and they are registered in each other's friend list in an SNS (Social Networking Service) program. Meanwhile, in this example, the user A and the user B are not registered in friendship information in the SNS program.

Now, the user A holds plural pieces of data such as the age, sex, occupation, and marital status as the owner attribute information. The terminal device of the fifth embodiment has a feature in that the output of the owner attribute information is controlled in accordance with the friendship information held by the execution of the SNS program. For example, the user A outputs just two pieces of owner attribute information, “age” and “sex”, to the user B while the user A outputs three pieces of owner attribute information, “age”, “sex”, and “hobby” to the user C because they are friends.

Fifth Embodiment: Functional Structure

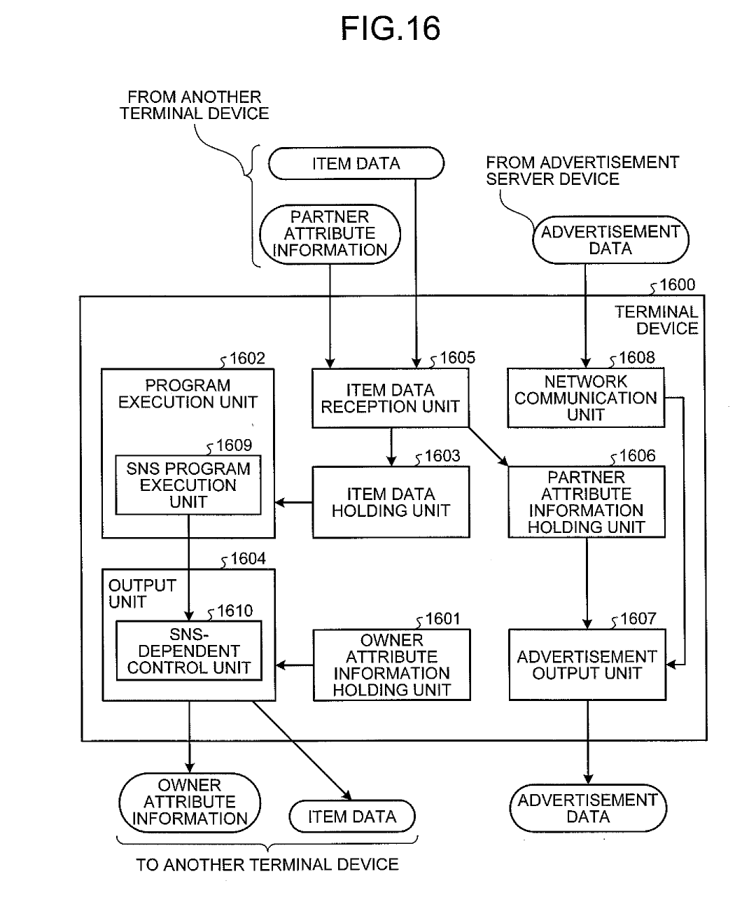

FIG. 16 illustrates an example of the function blocks of the terminal device in the fifth embodiment. A terminal device 1600 of the fifth embodiment illustrated in FIG. 16 includes an owner attribute information holding unit 1601, a program execution unit 1602, an item data holding unit 1603, an output unit 1604, an item data reception unit 1605, a partner attribute information holding unit 1606, an advertisement output unit 1607, and a network communication unit 1608. The program execution unit 1602 has an SNS program execution unit 1609 and the output unit 1604 has an SNS-dependent control unit 1610. Since the terminal device, the owner attribute information holding unit, the program execution unit, the item data holding unit, the output unit, the item data reception unit, the partner attribute information holding unit, the advertisement output unit, and the network communication unit are similar to those of the first embodiment (FIG. 2), the description of those units is omitted. Although not described, the count unit and the reception-frequency-dependent control unit in the advertisement output unit may be provided. In this case, the count unit and the reception-frequency-dependent control unit are similar to those of the second embodiment (FIG. 7); thus, the description of those units is omitted. Furthermore, although not described, the program execution unit may have the match game program execution unit and the output unit may have the output owner attribute information increase unit. In this case, the match game program execution unit and the output owner attribute information increase unit are similar to those of the third embodiment (FIG. 10); thus, the description of those units is omitted. Although not described, the approach count unit and the approach-frequency-dependent control unit in the output unit may be provided. In this case, since the approach count unit and the approach-frequency-dependent control unit are similar to those of the fourth embodiment (FIG. 13), the description of those units is omitted.

The SNS program execution unit 1609 executes an SNS program that utilizes the information of the friendship. SNS is a platform to build social networks over the Internet, and refers to the website that provides new social relations through the communication among people. In the SNS program, the procedure of processes is described in order for achieving the function of allowing communication in a bbs on a specific topic on the website of the SNS or the function of adding new friends to the friend list. The information of the friendship refers to the information for representing the friend relationship that holds when the user sends a request to the other user and the other user accepts the request. The information of friendship may include the information that represents the closeness among the friends.

The SNS-dependent control unit 1610 controls the output of the owner attribute information in accordance with the information of the friendship held by the execution of the SNS program. The output control in accordance with the friendship information refers to, for example, the control for outputting more owner information to the user as the friend and outputting much more owner information to the user as the close friend.

The owner attribute information refers to the information related to the attribute of the owner, and specific examples thereof include age, sex, occupation, marital status, residence, place of birth, hobby, and likes. The output control of the owner attribute information includes the output of more or fewer items out of the items in the above specific example, the output of just the summary of each item, or the output of the details of the item (for example, in the item of age, the age is expressed in periods of ten years or expressed as the exact age).

Fifth Embodiment: Hardware Structure

A hardware structure of the terminal device of the fifth embodiment is described with reference to FIG. 4. The portion added to the first to fourth embodiments is mainly described.

First, when the user operates to execute the SNS program through the input device or the like, the CPU 0401 executes the execution program set to the work region of the RAM 0403. For example, the execution program is used to search for the item data held in the HDD to obtain the item data, and display the item data. Along with the execution of the SNS program, the friendship information held in the RAM or the like may be updated.

When the output program is executed upon the operation of the user, the output program obtains the owner attribute information and the item data held in the HDD 0404, and then outputs the information and the data to another terminal device 0410 through the short-range wireless communication using the NFC as the communication circuit 0405. On this occasion, when the owner of the terminal device is judged as being a close friend of the owner of the other terminal device on the basis of the held friendship information, the process of controlling the output of the owner attribute information based on the friendship information is executed. Specifically, when the piece of the owner attribute information as the output target is extracted, the number of items is increased or the details of each item are selected and extracted. Moreover, the priority order of the output may be set among the pieces of owner attribute information in the form of priority codes.

Fifth Embodiment: Process Flow

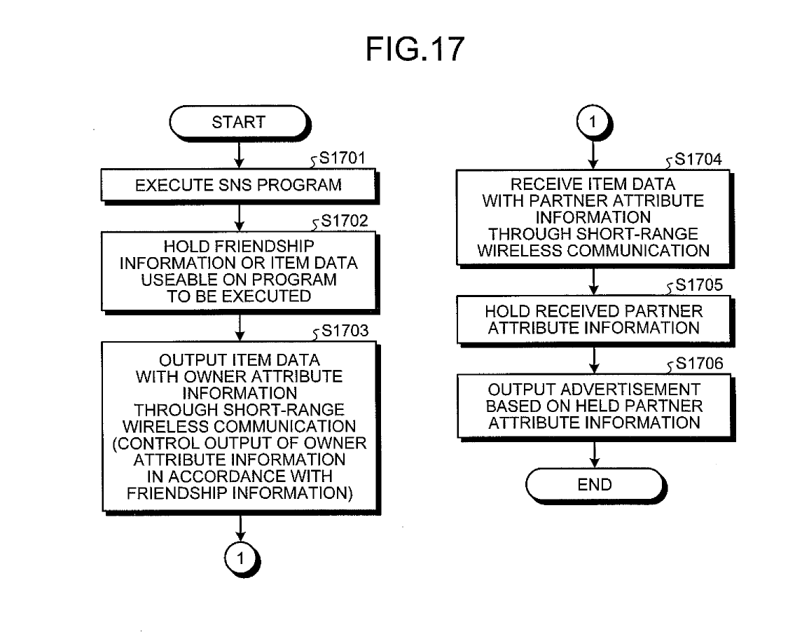

FIG. 17 illustrates an example of the flow of the process in the terminal device of the fifth embodiment. The portion added to the descriptions in the first embodiment (FIG. 5), the second embodiment (FIG. 8), the third embodiment (FIG. 11), and the fourth embodiment (FIG. 14) is mainly described. First, it is premised that the present terminal device has the owner attribute information holding unit holding one or more pieces of owner attribute information.

As the first step, the terminal device executes the SNS program (S1701). Next, the terminal device holds the item data that can be used on the program to be executed (S1702). On this occasion, the friendship information may be updated and held, for example. Subsequently, the terminal device controls the output of the owner attribute information in accordance with the friendship information held by the execution of the SNS program and outputs the owner attribute information with the item data through the short-range wireless communication including the peer-to-peer wireless communication (S1703).

After that, similarly, the partner attribute information and the item data are received from another terminal device through the short-range wireless communication including the peer-to-peer wireless communication (S1704) and held (S1705), and finally the process for outputting the advertisement on the basis of the held partner attribute information is performed (S1706).

Fifth Embodiment: Effect

The terminal device of the fifth embodiment can send more pieces of the owner attribute information to close friends by controlling the output of the owner information in accordance with the information of the friendship held by the execution of the SNS program. The output of the attribute information to many unspecified users that would occur when the terminals happen to pass on each other can be prevented.

### Sixth Embodiment

Sixth Embodiment: Outline

A sixth embodiment describes a driving program for the terminal device and a program server device for enabling the download of the driving program.

Sixth Embodiment: Functional Structure of Program Server Device

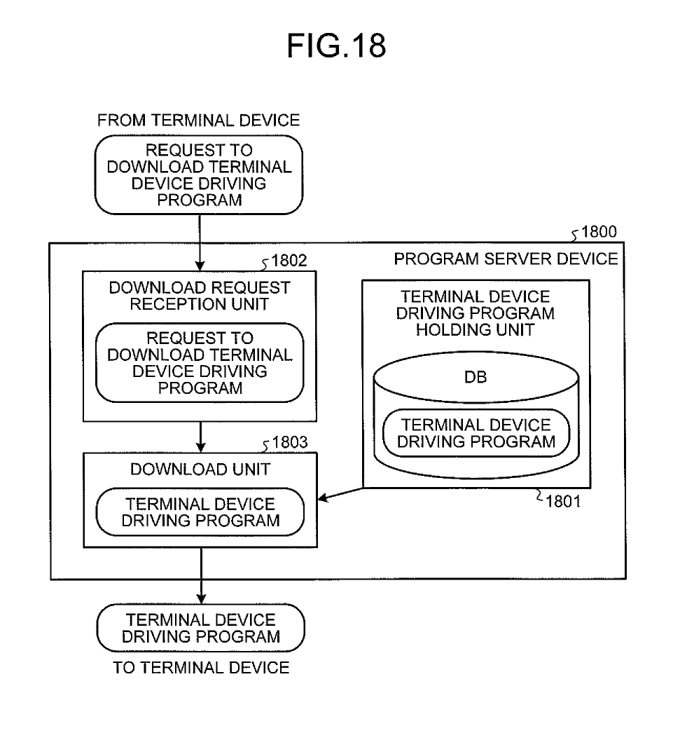

FIG. 18 illustrates an example of the function blocks of the program server device in the sixth embodiment. A program server device 1800 of the sixth embodiment illustrated in FIG. 18 includes a terminal device driving program holding unit 1801, a download request reception unit 1802, and a download unit 1803. The program server device 1800 is a server device that holds the terminal driving program, and executes the process of downloading the terminal driving program in response to the request from the terminal device.

The terminal device driving program holding unit 1801 holds the terminal device driving program. The terminal device driving program is a program allowing the terminal device to transmit and receive the item data and the owner attribute information to and from another terminal device through the short-range wireless communication. The details are described later.

The download request reception unit 1802 receives a terminal device driving program download request from the terminal device.

The download unit 1803 downloads the terminal device driving program in response to the download request. The program server device acquires the terminal device driving program that fulfils the download request from the terminal device driving program holding unit 1801 and downloads the program in the terminal device.

The terminal device having downloaded the terminal device driving program can execute the function of the terminal device described in the first to fifth embodiments by executing the terminal device driving program.

Sixth Embodiment: Terminal Device Driving Program

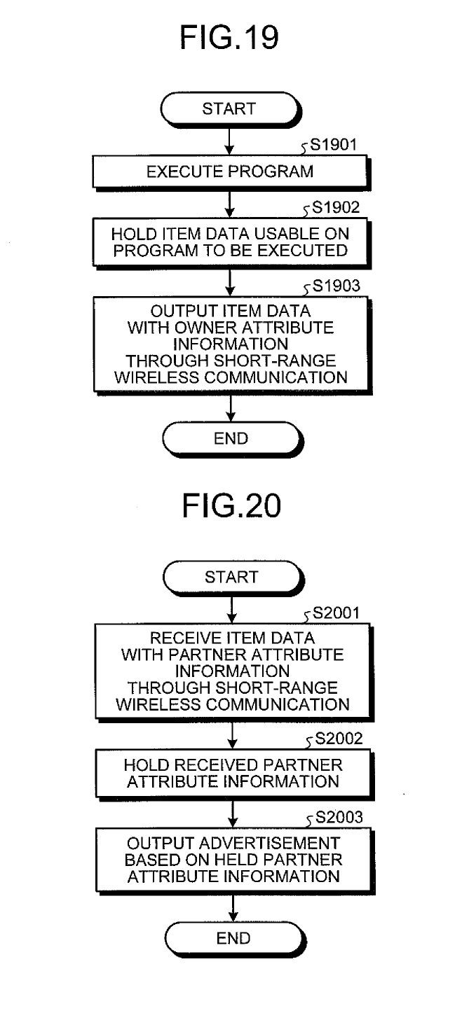

FIG. 19 and FIG. 20 illustrate the flow of the process in the terminal device driving program held in the program server device of the sixth embodiment. First, it is premised that the terminal device has the owner attribute information holding unit that holds one or more pieces of owner attribute information for driving the terminal device with the present driving program.

As the first step, the terminal device executes a program (S1901). Next, the terminal device holds the item data as the data of the item that can be used on the program to be executed (S1902). Finally, the terminal device outputs the held item data with the held owner attribute information through the short-range wireless communication including the peer-to-peer wireless communication (S1903). Through these process steps, the program for driving the terminal device is formed.

The driving program for the terminal device may be formed by adding the steps illustrated in FIG. 20. First, the item data with the partner attribute information are received through the short-range wireless communication including the peer-to-peer wireless communication (S2001). Next, the received partner attribute information is held (S2002). Finally, the process of outputting the advertisement on the basis of the held partner attribute information is executed (S2003).

According to an embodiment, provided is a terminal device that transmits and receives the attribute information of an owner himself or his partner together with item data as data of an item that can be used on a program to be executed, through short-range wireless communication including peer-to-peer wireless communication, and that outputs an advertisement to a terminal device of the partner on the basis of the received partner attribute information. When the advertisement is output based on the partner attribute information, the terminal device may control the advertisement output in accordance with the number of times of receiving the item data. Moreover, when the item data are output to a partner with whom the owner has played a match game through the short-range wireless communication, the terminal device may increase the owner attribute information to be output with the item data. Alternatively, the terminal device may control the output of the owner attribute information in accordance with the number of times of approaches that is counted for every terminal device. Additionally, the terminal device may control the output of the owner attribute information in accordance with the information of the friendship held by the execution of an SNS program.

Moreover, according to an embodiment, a terminal device driving program for driving a terminal device, a program server device for performing a process for downloading the terminal device driving program to the terminal device, and an advertisement server device for transmitting advertisement data to the terminal device are provided.

A terminal device according to an embodiment has an effect that the advertisement distribution with a higher sales promotion effect can be achieved by using the attribute information received from the partner that the owner actually faces through the short-range wireless communication including the peer-to-peer wireless communication and outputting the advertisement based on this partner attribute information. In other words, on the side which receives the output of the advertisement, the advertisement comes from the partner in a close relationship whom the user faces actually and with whom the user communicates through the short-range wireless communication; therefore, the advertisement is highly likely to be viewed positively in relation to the interest in or closeness toward the communication partner. Even when the advertisement is not necessarily interesting because the advertisement is transmitted to many and unspecified people, it is expected that some people are motivated to access the advertisement depending on the relation with the communication partner.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal device comprising:
an owner attribute information holding unit that holds one or more pieces of owner attribute information;
a program execution unit that executes a program;
an item data holding unit that holds item data as data of an item that can be used on the program to be executed;
an output unit that outputs the held item data with the held owner attribute information through short-range wireless communication including peer-to-peer wireless communication;
an item data reception unit that receives the item data with partner attribute information through short-range wireless communication including peer-to-peer wireless communication;
a partner attribute information holding unit that holds the partner attribute information received in the item data reception unit;
an advertisement output unit that outputs an advertisement on a basis of the held partner attribute information; and
a network communication unit.

2. The terminal device according to claim 1, further comprising a count unit that counts a number of times of receiving the item data for every partner, wherein the advertisement output unit has a reception-frequency-dependent control unit that controls advertisement output based on the partner attribute information in accordance with the number of times of reception for every partner.

3. The terminal device according to claim 1, wherein:
the program execution unit has a match game program execution unit that execute a match game program; and
the output unit has an output owner attribute information increase unit that increases pieces of the owner attribute information to be output with the item data when the item data are output to a partner with whom an owner has played the match game through the short-range wireless communication including the peer-to-peer wireless communication.

4. The terminal device according to claim 1, further comprising an approach frequency count unit that counts a number of times of approaches to another terminal device for every terminal device, wherein the output unit has an approach-frequency-dependent control unit that controls the output of the owner attribute information in accordance with the number of times of approaches counted for every terminal device.

5. The terminal device according to claim 1, wherein:
the program execution unit has an SNS program execution unit that executes an SNS program utilizing friendship information; and
the output unit has an SNS-dependent control unit that controls the output of the owner attribute information in accordance with friendship information held by execution of the SNS program.

6. An advertisement server device comprising:
a partner attribute information acquisition unit that acquires the partner attribute information from the terminal device according to claim 1;
an advertisement data acquisition unit that acquires data for an advertisement in accordance with the acquired partner attribute information; and
an advertisement transmission unit that transmits the acquired advertisement data to the terminal device from which the partner attribute information is acquired.

7. A computer-readable storage medium having stored therein a terminal device driving program for driving a terminal device, the terminal device having an owner attribute information holding unit that holds one or more pieces of owner attribute information, the terminal device driving program causing the terminal device to execute a process comprising:
executing a program;
holding item data as data of an item that can be used on the program to be executed; and
outputting the held item data with the held owner attribute information through short-range wireless communication including peer-to-peer wireless communication.

8. The computer-readable storage medium according to claim 7, wherein the process further comprises:
receiving the item data with partner attribute information through the short-range wireless communication including the peer-to-peer wireless communication;
holding the partner attribute information received in the receiving; and
outputting an advertisement on a basis of the held partner attribute information.

9. A program server device comprising:
a terminal device driving program holding unit that holds the terminal device driving program according to claim 7;
a download request reception unit that receives a terminal device driving program download request from a terminal device; and
a download unit that downloads the terminal device driving program in response to the terminal device driving program download request.
